(19) United States
(12) Patent Application Publication
(10) Pub. No.: US 2013/0071640 A1
(43) Pub. Date: Mar. 21, 2013

(54) INSULATION HAVING A LAYERED STRUCTURE

(71) Applicant: Holger Szillat, Nuenchritz (DE)

(72) Inventor: Holger Szillat, Nuenchritz (DE)

(73) Assignee: WACKER CHEMIE AG, Munich (DE)

(21) Appl. No.: 13/700,688

(22) PCT Filed: Nov. 5, 2010
(86) PCT No.: PCT/EP2010/066950

§ 371 Date: Nov. 28, 2012

(30) Foreign Application Priority Data
May 31, 2010 (DE) 10 2010 029 513.2

(51) Int. Cl. E04B 1/78; B32B 9/04; B32B 5/16; E04B 1/76; B32B 5/02

(52) U.S. Cl. CPC E04B 1/78; E04B 1/7662; B32B 5/022; B32B 5/16; B32B 9/048
USPC 428/215; 252/62; 442/327; 428/331; 428/304.4; 264/122; 427/421.1; 427/430.1

(57) ABSTRACT

Insulation powders having high thermal insulation value contain at least one silica with a BET surface area of from 130-1200 m²/g and a D(50) of less than 60 μm, and a fiber material having a fiber diameter of 1-50 μm.

### CROSS-REFERENCE TO RELATED APPLICATIONS

This application is the U.S. national phase of PCT Appln. No. PCT/EP2010/066950 filed Nov. 5, 2010, which claims priority to German Application No. 10 2010 029 513.2 filed May 31, 2010, which are incorporated herein by reference.

### BACKGROUND OF THE INVENTION

### Field of the Invention

The invention relates to a thermally insulating powder mixture and a process for producing it.

Thermal insulation for saving energy has attained an important position within the framework of the desire for sustainable development and the increasing cost of energy. Thermal insulation is being accorded ever greater importance in view of increasing energy prices and increasingly scarce resources, the desire to reduce CO₂ emissions, the necessity of achieving a lasting reduction in energy consumption and also increasing future demands on protection against heat and cold. These increasing demands on optimization of thermal insulation apply equally to buildings, e.g. new buildings or existing buildings, and to cold insulation in the mobile, logistical and stationary sector.

Building materials such as steel, concrete, brickwork and glass and also natural stone are relatively good conductors of heat, so that the exterior walls of buildings constructed from them very quickly release the heat from the inside to the outside in cold weather.

Development therefore aims at improving the insulation properties by increasing the porosity of these building materials, e.g. in the case of concrete and brickwork, and secondly at cladding the exterior walls with thermal insulation materials.

The thermal insulation materials or insulating materials predominantly used at present are materials having low thermal conduction. Relevant materials are organic thermal insulation materials, for example foamed plastics such as polystyrene, Neopor, and polyurethane; wood fiber material such as wood wool and cork; vegetable or animal fibers such as hemp, flax, and wooland inorganic thermal insulation materials such as mineral wool and glass wool; foamed glass in plate form; calcium silicate and gypsum boards; mineral foams such as porous concrete, pumice, perlite and vermiculite.

These conventional thermal insulation materials are used predominantly in the form of foamed or pressed boards and shaped bodies. Thus, for example, it is possible to foam polyurethanes and polystyrenes directly into the hollow spaces of the building blocks (DE8504737) or, as per DE10229856, as cut-to-measure boards. According to DE10217548, this technology is also possible using cut-to-size mineral wool.

All these insulation embodiments have a thermal insulation effectiveness which is too low for the demanding requirements of the present. The thermal conductivities are all above 0.030 W/mK, and the materials therefore have a high space requirement and are, inter alia, not lastingly stable in terms of thermal insulation.

Further disadvantages are:
Excessively high moisture absorption and sensitivity to water.
Time-consuming and costly application to the exterior wall (e.g. by adhesive bonding, plugging, screwing, application of support systems, etc; here, heat bridges are sometimes preprogrammed).
Additional bonding layers, e.g. for adhesion of renders.
In the case of organic insulating layers, there is also the combustibility.

A very good insulating effect is displayed by vacuum insulation panels, known as VIPs for short. At a thermal conductivity of from about 0.004 to 0.008 W/mK (depending on core material and subatmospheric pressure), the vacuum insulation panels have a thermal insulating effect which is from 8 to 25 times better than conventional thermal insulation systems. They therefore make it possible to achieve slim constructions with optimal thermal insulation, which can be used both in the building sector and in the household appliance, refrigeration and logistics sectors. Vacuum insulation panels based on porous thermal insulation materials, polyurethane foam boards and pressed fibers as core material combined with composite films (e.g. aluminum composite films or metalized films) are generally known and have been adequately described (cf. VIP-Bau.de).

However, the VIP technology has the following disadvantages:

If air is admitted into these evacuated panels as a result of damage, this means the end of the very good thermal insulation. The insulating effect then corresponds only to that of the core materials used.

The life is also limited by diffusion of gases through the barrier or envelope into the vacuum panels. In the building sector, the following disadvantages are of particular importance:
The panels do not breathe due to the virtually gas-impermeable barriers necessary.
Handling and processability on site, in particular on building sites, are difficult or impossible.
Owing to the structure of the films, diffusion of ambient gases (mainly nitrogen, oxygen, CO₂ and vapor) always occurs. A long life is therefore not ensured and is instead finite.
Vacuum insulation panels are very expensive compared to conventional insulation materials.

Low thermal conductivities are displayed by porous thermal insulation materials, e.g. those based on pyrogenic silica (0.018-0.024 W/mK). Pyrogenic silicas are produced by flame hydrolysis of volatile silicon compounds such as organic and inorganic chlorosilanes. These pyrogenic silicas produced in this way have a highly porous structure and are hydrophilic.

The disadvantages of these porous thermal insulation materials based on pyrogenic silicas are:

High moisture absorption, thus increasing thermal conductivity and thus a deterioration in the thermal insulation properties.
In the building sector, this can additionally lead to mold formation.
When used in vacuum panels, energy transport via water molecules can take place as a result of the moisture absorption and can have an adverse effect on the thermal conductivity of the system. Water molecules evaporate on the warm side and condense on the cold side. In this way, large quantities of energy are transported and the thermal conductivity of the system is thus increased.

### SUMMARY OF THE INVENTION

It is an object of the invention to solve the problems of the prior art, in particular to achieve a significant improvement in the properties of thermal insulation materials. The specific aim of the invention is an inexpensive, actively breathing, mechanically stable and highly effective thermal insulation having a low moisture absorption. These and other objects are achieved by a thermally insulating powder mixture with a bulk, density of 20-60 g/l, containing at least one silica with a BET surface area of 130-1200 m²/g, a D(50) of less than 60 μm, and at least one fiber material having a fiber diameter of 1-50 μm.

### DETAILED DESCRIPTION OF THE PREFERRED EMBODIMENTS

The invention thus provides a thermally insulating powder mixture which has a bulk density in accordance with DIN ISO 697 and EN ISO 60 of 20-60 g/l and contains at least one silica having a BET surface area in accordance with DIN ISO 9277 of preferably 130-1200 m²/g, more preferably 150-1000 m²/g, and most preferably 200-600 m²/g, and a D(50) which is preferably less than 60 μm, more preferably less than 30 μm, particularly preferably less than 15 μm, and at least one fiber material preferably having a fiber diameter of 1-50 μm.

The silica is preferably a precipitated silica, a silica having an aerogel structure, and more preferably, pyrogenic silica.

The thermally insulating powder mixture of the invention preferably comprises at least 15% by weight, more preferably at least 20% by weight, and most preferably at least 25% by weight, of a preferably hydrophobic silica preferably having a carbon content of at least 1% by weight, more preferably at least 4% by weight, and most preferably at least 7% by weight.

The thermally insulating powder mixture of the invention preferably comprises at least one hydrophobicizing agent from the group of silicone resins, fluorocarbon compounds, and carbon, preferably in an amount of 0.5-50% by weight, more preferably 1-30% by weight, and most preferably 2-15% by weight.

The thermally insulating powder mixture of the invention preferably comprises an IR opacifier.

The thermally insulating powder mixture of the invention preferably has a bulk density in accordance with DIN ISO 697 and EN ISO 60 of 2-150 g/l, more preferably 20-90 g/l, and yet more preferably 20-60 g/l, most preferably 20-40 g/l.

The thermally insulating powder mixture preferably comprises foamed or expanded powders in an amount of up to 60% by weight, more preferably up to 50% by weight, and most preferably up to 40% by weight. The foamed or expanded powders are preferably expanded perlite, an aluminum silicate, expanded mica (vermiculite), expanded clay, ceramic foam which is usually produced from aluminum oxide and foam-forming constituents, silicate foam which is usually produced from quartz flour, hydrated lime, cement, water and foaming agents, gypsum foam, foamed glass, expanded glass (a building material made of recycled glass), foamed polystyrene [depending on the method of production, a distinction is made between normal white and rather coarse-pored EPS, e.g. Styropor (BASF), and finer-pored XPS, e.g. Styrodur (BASF, color: green), Austrotherm XPS (color: pink) or Styrofoam (Dow Chemical, color: blue), and also Neopor (a further-developed foam based on foamed polystyrene)] and rigid resol foam, preferably expanded perlite, expanded mica, foamed glass, foamed polystyrene and rigid resol foam, and more preferably expanded perlite, foamed polystyrene and rigid resol foam.

The object is preferably achieved by a thermal insulation having a layer structure in which layers of conventional thermal insulation materials (hereinafter referred to as conventional insulation layers) are combined with layers of novel thermal insulation formulations (hereinafter referred to as novel insulation layers). The layer structure displays good cohesion of all components and layers and machinability together with a low density. The high thermal insulation performance of the layer structure is a further characteristic and rounds off the property spectrum of the novel thermal insulation. The use of adhesives which are located between the layers and would increase the thermal conductivity can be dispensed with.

Preferred conventional thermal insulation layers are:
a bed of a foamed or expanded inorganic material such as perlite, vermiculite, expanded clay or expanded mica which is held together by means of a binder,
an organic thermal insulation board such as foamed polystyrene, Neopor, resol or polyurethane,
a thermal insulation board composed of inorganic, porous insulation material such as pyrogenic silica admixed with an IR opacifier and glass fibers,
fiber nonwoven or fiber mat with or without impregnation with silica.

This conventional insulation material performs, first and foremost, the task of ensuring chemical compatibility with conventional elements of a thermal insulation façade, e.g. an insulating brick, or with an adhesive mortar and render of a composite thermal insulation system.

This also achieves satisfactory stability toward weather influences, e.g. driving rain. However, it is not sufficient for individual components to be resistant to driving rain since insulation materials may be cut to any size fitting the individual building to be insulated on the building site. As a result, novel thermal insulation formulation having the function of core insulation located between the conventional insulation materials can be partially exposed to weather influences. This is particularly critical when the main component of the core insulation is silica. In the untreated state, silica has a high affinity to moisture. The mechanism of moisture absorption is as follows: in a first step, the moisture is physisorbed. The physisorption of water onto the silanol groups of the silica is reversible at room temperature. In a second step, chemisorption of moisture takes place. This step is irreversible at room temperature. In the case of significant introduction of moisture, the structure of the silica can be destroyed. This is referred to as a collapse of the structure and is associated with a drastic increase in the thermal conductivity of the insulation material. This imposes particular requirements on all layers of the novel thermal insulation system. A pronounced hydrophobicity is absolutely necessary in all layers.

Layers between the conventional insulation layers will hereinafter be referred to as novel insulation layers and are, according to the invention, characterized in that they contain at least one powder from the group consisting of pyrogenic silica, precipitated silica and silica having an aerogel structure. The BET surface area of the silicas is preferably in the range from 130 m²/g to 1200 m²/g. The silica powders can also be used in combination. The proportion by weight of the silicas in the novel insulation layer is preferably 30-99% by weight, more preferably 50-97% by weight, and most preferably 60-95% by weight. Without surface treatment, the silica is referred to as a hydrophilic silica.

Part of the silica in the novel thermally insulating powder mixture and the novel insulation layer is preferably surface-modified. The surface treatment can be adsorbed on the silica or can have reacted partially or completely with the silanol groups of the silica. A preferred surface treatment preferably contains hexamethyldisilazane, poly-dimethylsiloxane (PDMS) or alkylsilanes. The surface treatment particularly preferably leads to a carbon content of at least 4% by weight in the silica. In the case of a surface treatment, the silica is referred to as a hydrophobic silica. It is also possible to use combinations of hydrophilic and hydrophobic silicas. The weight ratio of hydrophobic silicas to hydrophilic silicas is preferably at least 1:4.5, more preferably at least 1:4. The proportion of hydrophobic silica in the novel insulation layer is at least 15% by weight. The hydrophobic silica is most preferably a hydrophobic pyrogenic silica.

Furthermore, the novel thermally insulating powder mixture and the novel insulation layers preferably contain at least one fiber material. Preference is given here to, for example, glass wool, rock wool, basalt wool, slag wool, ceramic fibers, carbon fibers, silica fibers, cellulose fibers, textile fibers and polymer fibers, e.g. poly-propylene, polyamide or polyester fibers. The fiber material can also be surface-modified, e.g. it can contain an organic size or another modification such as poly-dimethylsiloxane (PDMS). A preferred fiber diameter is preferably from 0.1 μm to 200 μm, more preferably 1-50 μm, and most preferably in the range from 3 to 10 μm, with the length preferably being 1-25 mm, more preferably 3-10 mm. The amount of fiber material is preferably 0.5-20% by weight, more preferably 1-10% by weight, and most preferably 2-6%.

Preferred types of fibers are glass fibers, silica fibers and cellulose fibers. Particular preference is given to cellulose fibers.

The third component of the novel thermally insulating powder mixture and the novel insulation layer is preferably a hydrophobicizing powder which is characterized in that it is still solid at or above −30° C. Suitable powders are powders which have a hydrophobic action against water, e.g. preferably silicone resins (e.g. polymethylsiloxanes or polyalkylphenylsiloxanes and copolymers thereof with alkyd, acrylic or polyester resins or polyethers), polyfluorocarbon compounds, acrylic resins, oligomeric siloxanes, organosilanes, silicic esters or silicates with hydrophobicizing additives, siliconates, stearates, paraffins, fatty acids, fatty acid esters, wax esters, ceresins, bitumen, alkyd resins, acrylate copolymers (e.g. organosilicon-acrylate copolymers), styrene copolymers (e.g. butadiene-styrene copolymers or carboxylated butadiene-styrene copolymers), polyvinyl acetate, polyvinyl propionate, polystyrene acrylates, vinyl chloride copolymers, vinyl acetate copolymers, vinyl terpolymers, polyolefins, ethylene copolymers, propylene copolymers, thermoplastic polymers and polymer blends (e.g. of polyethylene or polypropylene and ethylene/vinyl acetate or ethylene/acrylate copolymers, optionally silane-crosslinked to increase the softening temperature) and carbon. The hydrophobicizing agents mentioned can be used individually or in combination.

To obtain a solid in the form of a powder, it is necessary in the case of some of the hydrophibicizing agents mentioned, e.g. oligomeric siloxanes and organosilanes, for these to be cooled to down to −30° C.

Preferred hydrophobicizing agents among those mentioned are preferably silicone resins, polyfluorocarbon compounds, acrylic resins, stearates, wax esters, alkyd resins, acrylate copolymers, polyvinyl acetate, vinyl chloride copolymers, vinyl acetate copolymers and vinyl terpolymers and carbon. Particular preference is given to silicone resins, polyfluorocarbon compounds and carbon. Among silicone resins, polyfluorocarbon compounds and carbon, preference is given to polyalkylsilicone resins, polyphenol silicone resins, polytetrafluoroethylenes (PTFE), tetra-fluoroethylene-perfluoro(methyl vinyl ether) copolymers (MFA), perfluoroethylene-propylene (FEP), perfluoroalkoxy polymers (PFA), copolymers of ethene and tetrafluoroethene having the formula ˜CH₂—CH₂—CF₂—CF₂˜ (ETFE), copolymers of ethylene, tetrafluoroethylene and hexafluoropropylene (EFEP), polyvinyl fluoride (PVF), polyvinylidene fluorides (PVDF), polychlorotrifluoroethylenes (PCTFE) and graphite.

Among the polyfluorocarbon compounds, particular preference is given to PTFE and PVDF.

The hydrophobicizing powders preferably have a particle size of less than 1 mm, more preferably less than 500 μm, yet more preferably less than 200 μm, and most preferably less than 80 μm.

The softening point of the hydrophobicizing powder is preferably in the range from −30° C. to 600° C., more preferably from 20° C. to 450° C., and most preferably from 40° C. to 370° C. The powders can be used individually or in combination. The amount of the hydrophobicizing powder in the novel insulation layer is preferably 0.5-50% by weight, more preferably 1-30% by weight, and most preferably 2-15% by weight.

An IR opacifier is preferably added to the novel thermally insulating powder mixture and the novel insulation layer. Possibilities are, for example, C, SiC, ilmenite, zirconium silicate, iron oxide, TiO₂, ZrO₂, manganese oxide, and iron titanate. The particle size of these powders is preferably in the range from 100 nm to 100 μm, more preferably from 0.5 μm to 15 μm, and most preferably from 1 to 10 μm. The amount is preferably 1-40% by weight, more preferably 2-30% by weight, and most preferably 3-8% by weight.

Further oxide which can also be hydrophobicized, are preferably added to the novel thermally insulating powder mixture and novel insulation layer. Preference is given to using, inter alia, alkaline earth metal oxides, silicates, specific sheet silicates and silicas. These preferably include various, synthetically produced modifications of silicon dioxide, e.g. electric arc silicas, silicas from residue combustion plants and fumed silica and also silicas produced by leaching silicates such as calcium silicate, magnesium silicate and mixed silicates, e.g. olivine (magnesium iron silicate) with acids. Further compounds which can be used are naturally occurring SiO₂-containing compounds such as diatomaceous earths and kieselguhrs. Depending on requirements, finely divided metal oxides such as aluminum oxide, titanium dioxide, iron oxide can be added. The amount can be up to 50% by weight.

A further addition to the novel thermally insulating powder mixture and novel insulation layer preferably consists of one or more foamed or expanded powders, preferably perlite, vermiculite, expanded clay, expanded mica, polystyrene, Neopor or polyurethane. In order to achieve a low density, foaming is preferably carried out after shaping of the novel insulation formulation. The amount used can be up to 60% by weight.

To achieve a low density, preference is also given to using classical pore formers, preferably cellulose and derivatives thereof.

The density of the novel insulation layer is preferably in the range from 30 to 500 g/l. It is advantageous in terms of the economics of the insulation to use very low densities. It has surprisingly been found that the novel insulation layer has a high strength even at low density. A preferred density for the purposes of the invention is preferably in the range from 30 to 150 g/l, more preferably from 70 to 120 g/l.

A further particular aspect is that in contrast to previous experience, no deterioration in the thermal insulation efficiency has to be accepted despite the low density. It is known, for example, that insulations based on pyrogenic silica have a lower thermal conductivity with increasing density because the contribution of gas conduction decreases because of smaller pores. The thermal insulation can be improved in this way up to a density of preferably about 250 g/l. Above about 250 g/l, the thermal conduction increases slightly again because of the increasing contribution of solid state conduction.

In the present case of the novel insulation layer, the lowest thermal conductivity values are achieved at a low density of from 60 to 120 g/l. The values which can be achieved at this density are in the range from 12 to 24 mW/mK.

The invention further provides a process for producing the thermally insulating powder mixture, characterized in that at least one silica having a BET surface area in accordance with DIN ISO 9277 of 130-1200 m²/g, which has been intensively predispersed and has a d₍₅₀₎ (D(50) of less than 60 μm, and at least one fiber material having a fiber diameter of 1-50 μm are mixed in the presence of high shear forces. The process of the invention serves to produce novel insulation layers which can be in the form of thermal insulation material mixtures or as shaped thermal insulation bodies formed by compacting thermal insulation material mixtures by means of a pressing operation.

The novel insulation layers are produced by intensive mixing of the powders. This forms novel insulation material mixtures. They can then preferably be compacted by means of a pressing operation to form a shaped body. The temperature can be increased after pressing. This leads, after cooling, to strengthening of the insulation material mixtures and shaped bodies. The coherence of a plurality of insulation layers is achieved by mechanical interlocking of the fibers among one another and with the other insulation layers during pressing and also as a result of softening or liquefaction of the hydrophobicizing agent as a result of the temperature increase, which results in wetting of the interfaces of the layers and the surfaces of the powders and shaped bodies, and solidification of the hydro-phobicizing agent after the temperature is reduced.

The production of the novel thermal insulation material mixtures can generally take place in various mixing and dispersing apparatuses. However, high-shear devices are preferably employed.

Here, it is not absolutely necessary but advantageous firstly to predispersibly deagglomerate the silica and then disperse it with the remaining components under high shear.

In a preferred procedure, the silica is firstly pre-dispersibly deagglomerated and then total amount of fibers is firstly premixed with part of the silica as a type of masterbatch so as to ensure complete separation of the fibers. The masterbatch preferably contains fibers and silica in a ratio of not more than 1:10, more preferably not more than 1:5. After the fibers have been separated, the remaining silica and the remaining components except for the hydrophobicizing powder are added.

As an alternative, the masterbatch can also contain the total amount of IR opacifier and fibers. After intensive dispersing, the predispersed silica is added thereto and intensively mixed in. Finally, the remaining components except for the hydrophobicizing agent are mixed in.

As a last step in the mixing sequence, the hydrophobic powders are added. Here, it may be necessary to cool the mixture and the hydrophobicizing agent so that the hydro-phobicizing agent can be mixed in as a solid. Since energy is liberated during mixing, the cooling temperature may have to be very low in order for the hydrophobicizing agent to remain solid and be able to be intensively mixed in under high shear.

After the mixing process is complete, the bulk density of the mixture is, depending on type and amount of the components, preferably 20-150 g/l, more preferably 20-90 g/l, yet more preferably 20-60 g/l and most preferably 20-40 g/l.

In order to achieve a high homogeneity and such a low bulk density of the mixture, which is preferably 20-40 g/l, particularly high shear forces are necessary. The shear rate during mixing is preferably above 10 m/s, more preferably above 20 m/s, yet more preferably above 28 m/s, and most preferably above 50 m/s. Suitable mixing apparatuses are devices such as high-speed mixers, high-speed planetary mixers, cyclone mixers, fluid mixers, milling classifiers and other rotor-stator systems.

The aim of the high shear is to bring about high deagglomeration of the silica during predispersing and optimal separation of the fibers and also extremely homogeneous mixing of all powders during the further course of dispersing.

After deagglomeration, the D(50) of the silica is preferably below 60 μm, more preferably below 30 μm and most preferably below 15 μm. The D(95) of the silica is preferably below 150 μm, more preferably below 90 μm and most preferably below 25 μm. The lowest values are achieved by means of milling classifiers using a rotor.

To effect high-shear dispersing of the mixture, use is made of high-speed mixers, high-speed planetary mixers, cyclone mixers and rotor-stator systems. Very homogeneous mixing of the powders leads to an optimal strength of the resulting insulation board and to a particularly low thermal conductivity.

The hydrophobicizing agent can, if required, be milled to a very small particle size by means of milling or cryomilling before being used for producing the insulation mixture.

In a particular embodiment, the above-described mixture is further mixed with one or more foamed or expanded powders such as perlite, vermiculite, expanded clay, expanded mica, polystyrene, Neopor or polyurethane. The foamed or expanded powders are preferably added to the mixture described. Since the expanded or foamed powders are fragile under shear, the powder has to be mixed gently. A variety of apparatuses are possible here, for example paddle mixers, Vreico-Nauta mixers, Beba mixers, Ekato mixers. Avoidance of jamming of particles (e.g. between the tools or between container and tool) and the low shear rate are critical for the quality. The shear rate is below 5 m/s, preferably below 2 m/s, and most preferably below 1 m/s.

The powder flow of the resulting porous mixture is very good, so that it can also be pressed without problems and homogeneously to form boards and also, for example, be introduced and pressed into the hollow spaces of hollow building blocks.

The hydrophobicizing powder can be thermally after-treated. As a result of the thermal treatment above the melting point, the flow limit of the powder is exceeded and film formation and an even finer distribution within the insulation material are achieved. After solidification, a significant additional strengthening of the insulation material is observed. The combination of fibers and hydro-phobicizing powder gives the final insulation material layer a very high strength. The thermal after-treatment can be carried out before or after pressing.

A shaped thermal insulation body can be produced from the insulation mixture by means of a pressing operation in order to bring about further strengthening. For this purpose, the insulation mixture is, in one or more steps, introduced into the cavity of a pressing tool and compacted by means of a punch. The resulting density can preferably be in the range from 30 to 500 g/l, more preferably from 70 to 350 g/l, and most preferably from 80 to 250 g/l. In a specific embodiment, the density is in the range from 180 to 250 g/l.

The shaped body can additionally be treated by dipping or spraying. Here, preference is given to using a hydrophobic reagent which is liquid at room temperature, preferably silicone oil, alkylsilane or hexamethyldisilazane. Particular preference is given to silicone oil.

The novel insulation layer as shaped body or as powder mixture has a high thermal insulating effect. The thermal conductivity achieved is preferably 12-35 mW/mK, more preferably 12-24 mW/mK, and most preferably 12-20 mW/mK.

The thickness of the novel insulation layer may be in the range from 0.5 mm to 15 cm.

The novel insulation layer can be combined with conventional insulation layers to form thermal insulation. The number of layers can preferably be 2-30, more preferably 2-15 and most preferably 3-10. The novel and conventional insulation layers are preferably arranged alternately. The layer arrangement can be formed by combining finished insulation layers. In this case, the hydrophobicizing powder to be heat treated ensures cohesion in and between the layers. However, the layer arrangement can also be formed by pouring of various mixtures (here too, alternating arrangements of novel and conventional mixtures are preferred) and subsequent pressing and heat treatment. The adhesion between these layers is ensured by mechanical interlocking via the glass fibers and by means of the hydrophobicizing powder acting at the interface of the layers. In a specific embodiment, the insulation layers or the beds of loose material can be joined to one another by means of PU foam, bonding foams, bonding agents or adhesives. In a further specific embodiment, the cohesion is achieved by means of a wrapping. This can be a film or a nonwoven. The film or the nonwoven preferably has a low thermal conductivity.

In a particular embodiment, only the novel thermal insulation is used without being combined with conventional insulation layers.

In a further particular embodiment, the hydrophobicizing powder of the novel insulation layer can also be left out when at least one silica of the silica mixture selected or/and the IR opacifier is/are already hydrophobic.

Shaped bodies of various geometries and sizes, e.g. rings, disks and boards, can be made from the insulation layers. Preference is given to boards which, according to the invention, are used in the following insulation systems as:

insulation in hollow building blocks,

core insulation in multishell building blocks,

core insulation for vacuum insulation panels (VIP)

core insulation for composite thermal insulation systems (CTIS),

insulation in double masonry walls.

In the case of the vacuum insulation panels (VIPs), the thermal conductivity is reduced further to values of 1-10 mW/mK by evacuation of the residual gases still present in the nanosize voids to moderate subatmospheric pressures below 100 mbar (preferably 0.01-10 mbar) so as to suppress convection/gas conduction.

The microporous insulation boards which have been wrapped in nonwoven beforehand are introduced into a vacuum-tight envelope. These vacuum-tight envelopes can be aluminum composite films, metalized films or preferably a metallic envelope based on preferably stainless steel or tinned plate, or polymers, preferably polypropylene. The metallic envelopes preferably have a coextruded coating based on a polyolefin terpolymer having excellent adhesion to the metal and good barrier properties toward air and water vapor.

After introduction of the microporous thermal insulation core into the film bag, the insulation boards are placed in a vacuum chamber and evacuated to the intended final pressure. The microporous thermal insulation boards introduced into the film bag are welded in the vacuum chamber.

In the case of the metallic envelope, the microporous insulation core is introduced into the lower metal shell and evacuated in the vacuum chamber and an accurately fitting lid is then pressed onto the lower shell. The two metal parts (lower shell and lid) are preferably coated with a coextruded polyolefin layer (thickness preferably 0.05-0.5 mm, more preferably 0.2-0.4 mm) in order to avoid heat bridges as a result of direct metal contact.

As thermoplastic, preference is given to using a polypropylene-polyethylene-acrylate terpolymer which has excellent adhesion to the metal and good barrier properties.

The VIPs produced in this way thus have an envelope impermeable to diffusion, are insensitive to damage and are thus predestined for use in the building sector.

To avoid heat bridges caused by the metallic envelope, especially in the case of small dimensions, preferably mechanically stable envelopes based on PP or PP/PVDC composite systems in which a gas-impermeable aluminum composite film is laminated onto the entire upper/lower surface, with only the outer margin consisting of pure PP/PVDC, are used.

The novel thermal insulation layer systems can be used in the evacuated and nonevacuated state (VIP), preferably in various thermal insulation applications. A preferred application is in the building sector. The insulation according to the invention is suitable for renovation of old buildings and also for new constructions, e.g. preferably for floor and roof insulation and also for interior or exterior insulation of exterior walls. Here, the novel insulation system can preferably be used directly as core material of a masonry wall, as part of a composite thermal insulation system (CTIS) or together with a metal or polymer envelope.

In the case of composite thermal insulation systems, the panels are preferably provided with envelopes consisting of a pressed, rolled, extruded, foam or fiber material in order to stabilize them, with the core being able to be maintained either under atmospheric pressure or under subatmospheric pressure. The envelope can, for normal conditions, have one or two flat areas or can envelope all surfaces of the panel, but can also have a multilayer structure and can consist of the same enveloping material or different enveloping materials on the various sides of the panels. In the case of subatmospheric pressure conditions, the envelope naturally encloses all surfaces of the panel.

The reinforcing envelope can preferably consist of:

cardboard, wood, gypsum plasterboard, shrink films which are perforated after the shrinkage process, various polymers, nonwovens, glass fiber-reinforced plastics (GFP), preferably those based on polyester resin, epoxy resin or polyamide.

For the frictional joining of the envelopes, primarily when a plurality of layers are joined, preference is given to using adhesives. These are preferably selected from among inorganic components such as water glasses, silica sols and phosphates and also organic compounds such as reactive resins, polymer dispersions or thermoplastics.

In the case of composite thermal insulation systems (CTIS), the novel insulation materials according to the invention can, owing to their high hydrophobicity, also be used directly, i.e. without vacuum and envelope. Typically, they are then preferably provided with a reinforcing layer and a render layer.

The invention further provides shaped bodies, building blocks, building systems and composite building systems which comprise the thermal insulation materials according to the invention, where these shaped bodies, building blocks, building systems and composite building systems consist partly or entirely of the thermal insulation materials.

The hydrophobic porous thermal insulation materials described above in the context of the invention are, according to the invention, preferably used in hollow building blocks.

Hollow building blocks are building elements which have one or more hollow spaces. They can preferably consist of inorganic, ceramic materials such as fired clay (brick), concrete, glass, gypsum and natural products such as natural stone, e.g. calcareous sandstone. Preference is given to using hollow building blocks made of brick, concrete and lightweight concrete.

Embodiments are wall building blocks, floor slabs, ceiling elements and façade elements.

It is known that the hollow spaces of these building elements can be filled with porous insulation materials having the shape of the hollow space, e.g. Styropor foam or perlite foam (DE3037409A1 and DE-OS2825508). These building elements are also referred to as hollow building blocks having integrated thermal insulation.

Hollow building blocks having integrated thermal insulation have the advantage that the brickhouse character is retained in the building construction.

The use of these hollow building blocks having integrated thermal insulation is intended to ensure particularly good thermal insulation and a favorable water vapor permeability and virtually no water absorption in the masonry; in addition, storage of heat should be promoted.

The insulation materials in these hollow building blocks having integrated thermal insulation can be of either organic or inorganic origin.

As organic materials, preference is given to using foamed polystyrene particles as insulating material. Here, the foamed polymer particles are joined and anchored to one another at the surface leaving gas-permeable interstices free.

Production is carried out by filling the hollow spaces with a bed of styrene pellets and subsequently foaming them by means of hot gases, usually steam. Such insulating building blocks have an improved thermal insulation capability. A disadvantage is the combustibility of the organic constituents of these building elements. Likewise, the thermal insulation capability decreases greatly with time due to the absorption of water/moisture.

As inorganic materials for hollow building blocks having integrated thermal insulation, preference is given to using foamed perlites and vermiculites. Foamed perlites which have been bonded and strengthened by means of binders such as aqueous dispersions based on vinyl acetate and acrylic-vinyl acetate copolymers are preferred. These fillings with the necessary binders have a high proportion of combustible components, and the resulting thermal insulation is also not optimal.

Bonding and strengthening of the perlites can preferably likewise be carried out using alkali metal water glasses as binders. This process leads to core materials which are strongly alkaline, water-attracting and lead to efflorescence. The already unsatisfactory thermal insulation properties are reduced still further. The use of silica sol as binder leads to poorly consolidated insulation material having a high water absorption and poor thermal insulation properties.

As a result of the use according to the invention of the hydrophobic porous thermal insulation materials described in hollow building blocks, the thermal insulation properties of these blocks are significantly improved and lastingly kept at a high level.

According to the invention, the corresponding thermal insulation materials can be pressed to form dimensionally accurate boards and be integrated into the chambers of the hollow building blocks, but the novel mixture can also be introduced into the chambers of the building blocks and pressed directly in the chambers by means of pressing aids. As an alternative, dimensionally accurate boards can also be cut from previously produced large boards and integrated into the building blocks.

It is likewise possible to fix the plates in the hollow spaces by means of, preferably, polyurethane foam or other adhesive foams or adhesives.

Likewise, the insulation material can be enveloped in preferably nonwoven materials in order to prevent, for example, mechanical influences and thus emission of dust from the thermal insulation.

To make optimal use of the effectiveness of the thermal insulation which can be achieved relative to the economics, inventively effective combinations of highly efficient hydrophobic porous thermal insulation with conventional thermal insulation systems having low thermal insulation effects are possible. Likewise, depending on the use and insulation capability, individual hollow chambers or a plurality of hollow chambers without thermal insulation materials can also be provided.

The invention is illustrated by way of example in the following embodiments:

For the purposes of the present invention, unless stated otherwise, all amounts and percentages are by weight and all percentages are based on the total weight, all temperatures are 20° C. and all pressures are that of the surrounding atmosphere, i.e. from 900 to 1100 hPa. All viscosities are determined at 25° C.

In the following examples, all parts and percentages indicated are, unless stated otherwise, by weight. Unless stated otherwise, the following examples are carried out at the pressure of the surrounding atmosphere, i.e. at about 1000 hPa, and, unless stated otherwise, at room temperature, i.e. about 20° C. or a temperature which is established on combining the reactants at room temperature without additional heating or cooling. All viscosities reported in the examples are based on a temperature of 25° C.

### Example 1

Components:

Hydrophilic pyrogenic silica having a BET surface area of 300 m²/g: 88% by weight

Glass fibers (length 6 mm, thickness 7 μm): 2% by weight

SiC (D(50)=5 μm): 4% by weight

Silicone resin polymethylsiloxane, milled by means of the cryomill to D(50)=10 μm: 6% by weight

6.5 g of fibers, 15.2 g of SiC and 50 g of silica were firstly premixed for 3 minutes in a cyclone mixer at 15,000 rpm to separate the fibers. The remainder of the solid components (285.5 g of silica) was subsequently added and mixing was continued for a further 2 minutes under the same mixing conditions. 22.8 g of silicone resin were then added to this mixture and the mixture was stirred for a further one minute.

238 g of the finished mixture were taken out and pressed to give a solid body having exterior dimensions of 200×200×38 mm, so that a density of 120 g/l resulted. This shaped body was subsequently heated at 70° C. for 120 minutes.

### Example 2

Components:

Hydrophilic pyrogenic silica having a BET surface area of 300 m²/g: 80% by weight

Glass fibers (length 6 mm, thickness 7 μm): 4% by weight

SiC (D(50)=5 μm): 4% by weight

Fluorocarbon compound PVDF (milled by means of a cryomill to D(50)=20 μm): 12% by weight

14 g of fibers, 15 g of SiC and 50 g of silica were firstly premixed for 3 minutes in a cyclone mixer at 15,000 rpm to separate the fibers. The remainder of the solid components (255 g of silica) was subsequently added and mixing was continued for a further 2 minutes under the same mixing conditions. 46 g of PVDF powder were then added to this mixture and the mixture was stirred for a further one minute.

238 g of the finished mixture were taken out and pressed to give a solid body having exterior dimensions of 200×200×38 mm, so that a density of 120 g/l resulted. This shaped body was subsequently heated at 190° C. for 120 minutes.

### Example 3

Components:

Hydrophilic pyrogenic silica having a BET=300 m²/g and hydrophobic pyrogenic silica having a BET surface area of 200 m²/g and a C content of 5% resulting from a PDMS coating: 63+27% by weight, respectively

Cellulose fibers (length 6 mm, thickness 7 μm): 6% by weight

Graphite powder (D(50)=4 μm): 4% by weight

The hydrophilic and hydrophobic silicas were firstly broken up in a milling classifier (rotor 7000 rpm, classifier 6500 rpm) until the D(50) was 10 μm. The two silicas, the fibers and the graphite powder were then mixed for 10 minutes in a cyclone mixer at 15,000 rpm.

200 g of the finished mixture were taken out and pressed to give a solid body having exterior dimensions of 200×200×38 mm, so that a density of 100 g/l resulted.

### Example 4

Components:

Hydrophilic pyrogenic silica having a BET=300 m²/g and hydrophobic pyrogenic silica having a BET surface area of 200 m²/g and a C content of 5% resulting from a PDMS coating: 63+27% by weight, respectively

Cellulose fibers (length 6 mm, thickness 7 μm): 6% by weight

Graphite powder (D(50)=4 μm): 4% by weight

The hydrophilic and hydrophobic silicas were firstly broken up in a milling classifier (rotor 7000 rpm, classifier 6500 rpm) until the D(50) was 10 μm. The two silicas, the fibers and the graphite powder were then mixed for 10 minutes in a cyclone mixer at 15,000 rpm.

400 g of the finished mixture were taken out and pressed to give a solid body having exterior dimensions of 200×200×38 mm, so that a density of 190 g/l resulted.

### Example 5

The mixture from example 1 was brought to a density of 250 g/l and dipped into a bath of silicone oil for 20 s. The impregnated board was then heated at 210° C. in a drying oven for 30 minutes.

### Example 6

For a multilayer structure, the powder mixture from example 3 (mixture A) and hydrophobic perlite (0-1 perlite from Knauf) (mixture B) were employed. 3 cm beds of the mixture A and of the mixture B were introduced alternately into the cavity of a pressing tool until a total of 16 powder layers were present. The total bed was pressed to a density of 120 g/l.

### Example 7

For a three-layered structure, the insulation board from example 3 (but with the dimensions 245×245×50) was placed centrally in an insulation brick. The two unfilled sides were filled with hydrophobic perlite (0-1 perlite from Knauf). A foamed 0-1 perlite from Knauf which had been mixed with an aqueous dispersion based on vinyl acetate and acrylic-vinyl acetate copolymers was used. A punch compacted the perlite bed to 70 g/l. For bonding, the filled brick was heated at 140° C. for 60 minutes.

### Example 8

For a three-layer structure, the insulation board from example 4 was dipped into a bath of hexamethyldisilazane for 20 s. This board was then placed centrally between 2 boards of expanded polystyrene having a thickness of 10 cm. The system was heated at 60° C. for 60 minutes and after cooling to room temperature was wrapped in a glass fiber nonwoven. The new insulation was suitable for use in composite thermal insulation systems.

### Example 9

The insulation board from example 4 was wrapped in a glass fiber nonwoven and introduced into a vacuum-tight envelope of aluminum composite films. It was then evacuated to a pressure of 0.1 mbar and welded. The thermal conductivity of the resulting vacuum insulation panel is 4 mW/mK.

### Example 10

Components:

Hydrophilic pyrogenic silica having a BET=300 m²/g: 24% by weight

Hydrophobic pyrogenic silica having a BET surface area of 200 m²/g and a C content of 5% resulting from a PDMS coating: 27% by weight

Silica having an aerogel structure and a BET surface area of 500 m²/g: 39% by weight

Cellulose fibers (length 6 mm, thickness 7 μm): 6% by weight

Graphite powder (D(50)=4 μm): 4% by weight

The silicas were firstly broken up in a milling classifier (rotor 7000 rpm, classifier 6500 rpm) until the D(50) was 10 μm. They and the fibers were then firstly premixed in a cyclone mixer at 15,000 rpm for 6 minutes to separate the fibers. The graphite powder was subsequently added and mixing was continued for a further 2 minutes under the same mixing conditions.

400 g of the finished mixture were taken out and pressed to give a solid body having exterior dimensions of 200×200×38 mm, so that a density of 200 g/l resulted.

### Example 11

Components:

Hydrophilic pyrogenic silica having a BET=300 m²/g and hydrophobic pyrogenic silica having a BET surface area of 200 m²/g and a C content of 5% resulting from a PDMS coating: 39+27% by weight, respectively

Cellulose fibers (length 6 mm, thickness 7 μm): 6% by weight

Graphite powder (D(50)=4 μm): 4% by weight

Fumed silica (bulk density 190 g/l, BET 30 m²/g): 24% by weight

The hydrophilic and hydrophobic silicas were firstly broken up in a milling classifier (rotor 7000 rpm, classifier 6500 rpm) until the D(50) was 10 μm. They and the fibers were then firstly premixed in a cyclone mixer at 15,000 rpm for 3 minutes to separate the fibers. The graphite powder and fumed silica were subsequently added and mixing was continued for a further 2 minutes under the same mixing conditions.

200 g of the finished mixture were taken out and pressed to give a solid body having exterior dimensions of 200×200×38 mm, so that a density of 100 g/l resulted.

### Example 12

A glass fiber nonwoven having a thickness of 0.5 cm was placed in the bottom of a pressing tool. 400 g of the mixture from example 4 were introduced on top of this nonwoven. A further glass fiber nonwoven having a thickness of 0.5 cm was placed on top of the mixture. This assembly was pressed to give a solid body having exterior dimensions of 200×200×38 mm, so that a density of 200 g/l resulted. The novel insulation is suitable for use in composite thermal insulation systems.

### Example 13

Components:

Hydrophilic pyrogenic silica having a BET=300 m²/g and hydrophobic pyrogenic silica having a BET surface area of 200 m²/g and a C content of 5% resulting from a PDMS coating: 63+27% by weight, respectively

Cellulose fibers (length 6 mm, thickness 7 μm): 6% by weight

Graphite powder (D(50)=4 μm): 4% by weight

All components were mixed in a high-speed mixer at 4000 rpm (corresponds to a circumferential tool velocity of 55 m/s) for 15 minutes.

400 g of the finished mixture were taken out and pressed to give a solid body having exterior dimensions of 200×200×38 mm, so that a density of 190 g/l resulted.

### Example 14

500 g of the mixture from example 13 were mixed with 500 g of hydrophobic perlite (0-1 perlite from Knauf) in a Vreico-Nauta mixer at a shear rate of 2 m/s for 10 minutes. 200 g of the finished mixture was taken out and pressed to give a solid body having exterior dimensions of 200×200×38 mm, so that a density of 95 g/l resulted.

TABLE OF CONDUCTIVITIES

| | Density | λ value | |
|---|---|---|---|
| Mixture | (g/l) | (mW/mK) | Hydrophobicity |
| Example 1 | 120 | 20.9 | water drop penetration time 20 s |
| Example 2 | 120 | 19.8 | yes |
| Example 3 | 100 | 18.1 | yes |
| Example 4 | 190 | 17.3 | yes |
| Example 5 | 250 | 21.5 | yes |
| Example 6 | 120 | 30.2 | yes |
| Example 10 | 200 | 12.5 | yes |
| Example 11 | 100 | 22.2 | yes |
| Example 13 | 190 | 18.3 | yes |
| Example 14 | 95 | 29.5 | yes |

Determination of the hydrophobicity: application of a water drop to a board. If the drop soaks in within a time of 1 h: hydrophobicity no; if the drop does not soak in within a time of 1 h: hydrophobicity yes.

The determination of the thermal conductivity was carried out in accordance with EN 12667, EN 1946-3 and ISO 8301 by means of a Hesto Lambda Control HLC A60 measuring instrument.

The determination of the bulk density was carried out in accordance with DIN ISO 697 and EN ISO 60.

The determination of the BET surface area was based on DIN ISO 9277.

A Malvern Mastersizer laser light scattering instrument was used for determining the particle sizes of the powders in accordance with ISO 13320-1. The D(50) describes the average particle size. D(95) means that 95% of the particles are smaller than the value indicated. D(50) means that 50% of the particles are smaller than the value indicated.

The rotational speed of 15,000 rpm in the cyclone mixer corresponds to a circumferential tool velocity of 70 m/s.

1.-24. (canceled)

25. A thermally insulating powder mixture which has a bulk density in accordance with DIN ISO 697 and EN ISO 60 of 20-60 g/l, comprising at least one silica having a BET surface area in accordance with DIN ISO 9277 of 130-1200 m²/g and a D(50) of less than 60 μm, and at least one fiber material having a fiber diameter of 1-50 μm.

26. The thermally insulating powder mixture of claim 25, wherein the silica is a pyrogenic silica.

27. The thermally insulating powder mixture of claim 25, comprising at least 15% by weight of a hydrophobic silica having a carbon content of at least 1% by weight.

28. The thermally insulating powder mixture of claim 25, comprising at least one hydrophobicizing agent selected from the group consisting of silicone resins, fluorocarbon compounds and carbon, in an amount of 1-30% by weight.

29. The thermally insulating powder mixture of claim 25, further comprising an IR opacifier.

30. The thermally insulating powder mixture of claim 25, which has a bulk density in accordance with DIN ISO 697 and EN ISO 60 of 20-40 g/l.

31. The thermally insulating powder mixture of claim 25, further comprising at least one foamed or expanded powder.

32. The thermally insulating powder mixture of claim 25, comprising a plurality of layers of loose material.

33. A shaped thermal insulation body comprising a thermally insulating powder mixture of claim 25, and a density according to DIN ISO 697 and EN ISO 60 of 70-350 g/l.

34. The shaped thermal insulation body of claim 33, having a density of 70-120 g/l.

35. The shaped thermal insulation body of claim 33, having a thermal conductivity of 12-35 mW/mK measured in accordance with EN 12667, EN 1946-3 and ISO 8301.

36. The shaped thermal insulation body of claim 33, having a conductivity of 12-24 mW/mK measured in accordance with EN 12667, EN 1946-3 and ISO 8301.

37. The shaped thermal insulation body of claim 33, having a high hydrophobicity and a low water absorption in accordance with DIN EN 12087.

38. A thermal insulation having a layer structure, comprising from 2 to 20 adhering insulation layers of which at least one is a conventional insulation layer selected from the group consisting of a bed of a foamed or expanded inorganic material, held together by means of a binder;
an organic thermal insulation board;
a thermal insulation board composed of inorganic, porous insulation material optionally containing an IR opacifier and optionally glass fibers;
a fiber nonwoven optionally impregnated with silica, and
the thermal insulation having a layer structure and comprising at least one shaped insulation layer of claim 33.

39. The thermal insulation of claim 38, wherein the thickness of the layers is from 0.5 mm to 15 cm.

40. In a vacuum insulation panel (VIP) a hollow building block, multishell building block, double masonry wall or composite thermal insulation system (CTIS) employing insulation, the improvement comprising including in the insulation at least one thermal insulation comprising the thermally insulating powder of claim 25 or having been derived therefrom.

41. A process for producing the thermally insulating powder mixture of claim 25, comprising mixing at least one silica having a BET surface area in accordance with DIN ISO 9277 of 130-1200 m²/g and at least one fiber material having a fiber diameter of 1-50 μm in the presence of high shear forces.

42. The process of claim 41, wherein the silica is intensively predispersed.

43. The process of claim 41, wherein mixing is divided into the following steps:
intensive mixing of fibers and a proportion of silica,
intensive mixing-in of the remaining silica and the remaining components, optionally with cooling so as to avoid liquefaction of components.

44. The process of claim 41, wherein mixing is divided into the following steps:
intensive mixing of fibers and IR opacifier,
intensive mixing-in of the silica and the remaining components, optionally with cooling so as to avoid liquefaction of components.

45. The process of claim 41, further comprising mixing at least one foamed or expanded powder are in a last step.

46. The process of claim 41, wherein mixing is followed by a compaction step by means of pressing.

47. The process of claim 46, wherein the temperature is increased immediately before or directly after pressing and a last process step comprises cooling to room temperature.

48. The process of claim 46, wherein a resulting shaped body is sprayed with a hydrophobicizing reagent or is dipped into such a reagent.
